(19) United States
(12) Patent Application Publication
(10) Pub. No.: US 2009/0116848 A1
(43) Pub. Date: May 7, 2009

(54) OPTICAL COMMUNICATION SYSTEM AND METHOD USING MANCHESTER ENCODED SIGNAL REMODULATION

(75) Inventors: Bong-Kyu Kim, Daejeon-city (KR); Heuk Park, Daejeon-city (KR); Kwangjoon Kim, Daejeon-city (KR); Bong-Tae Kim, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/293,973

(22) PCT Filed: Feb. 21, 2007
(86) PCT No.: PCT/KR2007/000910

§ 371 Date: Sep. 22, 2008

(30) Foreign Application Priority Data
Mar. 21, 2006 (KR) 10-2006-0025684

(51) Int. Cl. H04B 10/00

(52) U.S. Cl. 398/140

(57) ABSTRACT

An optical communication system and method using Manchester encoded signal remodulation are provided. The optical communication system includes a transmitter generating and transmitting a Manchester encoded optical signal including a first data stream, and a receiver receiving an optical signal obtained by dividing power of the Manchester encoded optical signal into two parts and modulating one of the two parts to include a second data stream, and recovering the second data stream. In two-way communication, the optical communication system and method allow one party to generate and transmit a Manchester encoded signal (i.e., a downstream signal) to the other party and allow the other party to generate an upstream signal by modulating the optical power of the downstream signal without using a light source.

### TECHNICAL FIELD

The present invention relates to an optical communication system and method using Manchester encoded signal remodulation, and more particularly, to an optical communication system and method using a Manchester encoded signal or a modified Manchester encoded signal.

### BACKGROUND ART

Methods of remodulating a downstream signal transmitted from a single light source in a central office or an optical line terminator (OLT) and using the remodulated downstream signal as an upstream signal without using a light source in an optical network unit (ONU) have been suggested.

In a method of transmitting a signal without modulating a downstream signal (i.e., a signal transmitted from an OLT to an ONU) for a predetermined period of time [N.J. Frigo et al., IEEE Photonics Technology Letters, 1994, p. 1365], a non-modulated signal of a particular portion is transmitted for the transmission of upstream data information (i.e., transmission from the ONU to the OLT). In this method, only a downstream signal corresponding to a portion having no signal modulation is remodulated using upstream data and then transmitted to the OLT since when a modulated portion of a downstream signal is remodulated using upstream data, signals overlap each other and an error occurs in the transmission of upstream data information. However, a method of transmitting a non-modulated signal for a particular portion requires punctuality when data information is applied and thus has a disadvantage of requiring an additional control unit. Moreover, since the downstream signal has a half-duplex format and does not allow information to be applied in a whole section, a bandwidth cannot be used efficiently.

A method of modulating a downstream signal into inverse-return-to-zero (IRZ) data for upstream data information has been proposed [G. W. LU et al., OFC 2005]. An IRZ signal is an inverted signal of an RZ signal. With respect to a non-return-to-zero (NRZ) signal, an error occurs when a downstream signal is remodulated using upstream data since there is no optical output when a data value is ‘0’. To overcome this problem, an optical output should be transmitted when a data value is ‘0’. In contrast, with respect to an IRZ signal, an optical output is transmitted when a data value is ‘0’ and an optical output of a half period is transmitted when a data value is ‘1’, so that a downstream signal has a constant output. However, in the method using the IRZ signal, the intensity of optical power output when a data value is ‘0’ is different from that output when a data value is ‘1’, whereby fluctuation occurs in optical power and noise occurs. The noise deteriorates the transmission characteristics of a system.

A method of modulating a downstream signal using frequency-shift keying (FSK) [J. Prat et al., IEEE Photonics Technology Letters, 2005, p. 702] and a method of modulating a downstream signal using differential phase-shift keying (DPSK) [W. Hung et al., IEEE Photonics Technology Letters, 2003, p. 1476] have been proposed. However, when FSK or DPSK is used, the structure of an optical transceiver becomes complicate. As a result, manufacturing an ONU costs a lot.

### DISCLOSURE OF INVENTION

Technical Problem

The present invention provides a system and method for remodulating a Manchester encoded signal and using the remodulated signal as an upstream signal, thereby improving transmission characteristics.

Technical Solution

According to an aspect of the present invention, there is provided an optical communication system including a transmitter generating and transmitting a Manchester encoded optical signal including a first data stream, and a receiver receiving an optical signal obtained by dividing power of the Manchester encoded optical signal into two parts and modulating one of the two parts to include a second data stream, and recovering the second data stream.

According to another aspect of the present invention, there is provided an optical communication system including a divider receiving a Manchester encoded optical signal including a first data stream and dividing power of the Manchester encoded optical signal into two parts, a receiver recovering the first data stream from one of the two parts of the Manchester encoded optical signal, and a modulator modulating the other part of the Manchester encoded optical signal to include a second data stream.

According to still another aspect of the present invention, there is provided an optical communication system including a transmitting unit generating a Manchester encoded optical signal including a first data stream; a modulation unit dividing power of the Manchester encoded optical signal into two parts, recovering the first data stream from one of the two parts, and modulating the other part of the Manchester encoded optical signal to include a second data stream; and a receiving unit recovering the second data stream added by the modulation unit.

According to yet another aspect of the present invention, there is provided an optical communication method including generating a Manchester encoded optical signal including a first data stream, dividing power of the Manchester encoded optical signal into two parts, recovering the first data stream from one of the two parts, modulating the other part of the Manchester encoded optical signal to include a second data stream, and recovering the second data stream.

Advantageous Effects

The present invention uses a remodulated Manchester encoded downstream signal as an upstream signal, thereby decreasing costs for communication networks and improving transmission characteristics.

In an optical network, many ONUs or ONTs are connected to a single OLT. Accordingly, when the ONUs/ONTs use many different kinds of elements such as light sources having different wavelengths, have complex structures, or use expensive elements, installation costs increase and management costs also increase due to repair and replacement. Accordingly, technology for simplifying the structure of an ONU/ONT, integrating elements, and reducing manufacturing costs and technology for allowing a central office to control ONUs are important in the field of optical networks.

According to the present invention, an ONU does not include a light source and generates an upstream signal by remodulating a downstream signal to include upstream data using only a modulator. As a result, manufacturing costs are reduced and elements are standardized regardless of a light wavelength. Since a function of controlling a wavelength or output power of a light source is removed from an ONU, a system structure is simplified and management efficiency is increased.

An optical communication system using the present invention rarely has the deterioration of transmission characteristics and has a simple structure. Accordingly, costs for manufacturing, installation, and management of optical networks can be remarkably reduced. As a result, the present invention can revitalize a market for optical networks. The present invention is not restricted to optical networks but can be widely used in other fields.

### DESCRIPTION OF DRAWINGS

FIGS. 1A and 1B illustrate a Manchester encoded downstream signal according to an embodiment of the present invention;

FIG. 2 illustrates the relationship between a unit bit and a period in a modified Manchester encoded downstream signal, according to an embodiment of the present invention;

FIGS. 3A through 3C illustrate waveforms of an upstream signal obtained by modulating the Manchester encoded downstream signal illustrated in FIGS. 1A and 1B or FIG. 2;

FIG. 4 illustrates an optical communication system using the Manchester encoded downstream signal illustrated in FIGS. 1A and 1B or FIG. 2, according to an embodiment of the present invention;

FIG. 5 illustrates an optical communication system using a method of remodulating the Manchester encoded downstream signal illustrated in FIGS. 1A and 1B or FIG. 2 in synchronization with an upstream signal, according to an embodiment of the present invention;

FIG. 6 illustrates an optical communication system using the Manchester encoded downstream signal illustrated in FIGS. 1A and 1B or FIG. 2 with a single strand of optical fiber, according to an embodiment of the present invention;

FIG. 7 illustrates an optical communication system using a reflective semi-conductor optical amplifier (RSOA) instead of a modulator illustrated in FIG. 6, according to an embodiment of the present invention;

FIG. 8 is a graph showing the results of measuring characteristics of downstream signals transmitted by the optical communication system illustrated in FIG. 4;

FIG. 9 is a graph showing the results of measuring characteristics of upstream signals transmitted by the optical communication system illustrated in FIG. 4;

FIG. 10 is a graph showing the results of measuring characteristics of upstream signals transmitted by the optical communication system illustrated in FIG. 5 when each upstream signal and a downstream signal have the same data transmission rate and are synchronized with each other; and

FIG. 11 is a flowchart of an optical communication method performed by the optical communication system illustrated in FIG. 4, according to an embodiment of the present invention.

### BEST MODE

According to an aspect of the present invention, there is provided an optical communication system including a transmitter generating and transmitting a Manchester encoded optical signal including a first data stream, and a receiver receiving an optical signal obtained by dividing power of the Manchester encoded optical signal into two parts and modulating one of the two parts to include a second data stream, and recovering the second data stream.

According to another aspect of the present invention, there is provided an optical communication system including a divider receiving a Manchester encoded optical signal including a first data stream and dividing power of the Manchester encoded optical signal into two parts, a receiver recovering the first data stream from one of the two parts of the Manchester encoded optical signal, and a modulator modulating the other part of the Manchester encoded optical signal to include a second data stream.

According to still another aspect of the present invention, there is provided an optical communication system including a transmitting unit generating a Manchester encoded optical signal including a first data stream; a modulation unit dividing power of the Manchester encoded optical signal into two parts, recovering the first data stream from one of the two parts, and modulating the other part of the Manchester encoded optical signal to include a second data stream; and a receiving unit recovering the second data stream added by the modulation unit.

According to yet another aspect of the present invention, there is provided an optical communication method including generating a Manchester encoded optical signal including a first data stream, dividing power of the Manchester encoded optical signal into two parts, recovering the first data stream from one of the two parts, modulating the other part of the Manchester encoded optical signal to include a second data stream, and recovering the second data stream.

### MODE FOR INVENTION

Hereinafter, preferred embodiments of the present invention will be described in detail with reference to the attached drawings. Like reference numerals in the drawings denote like elements.

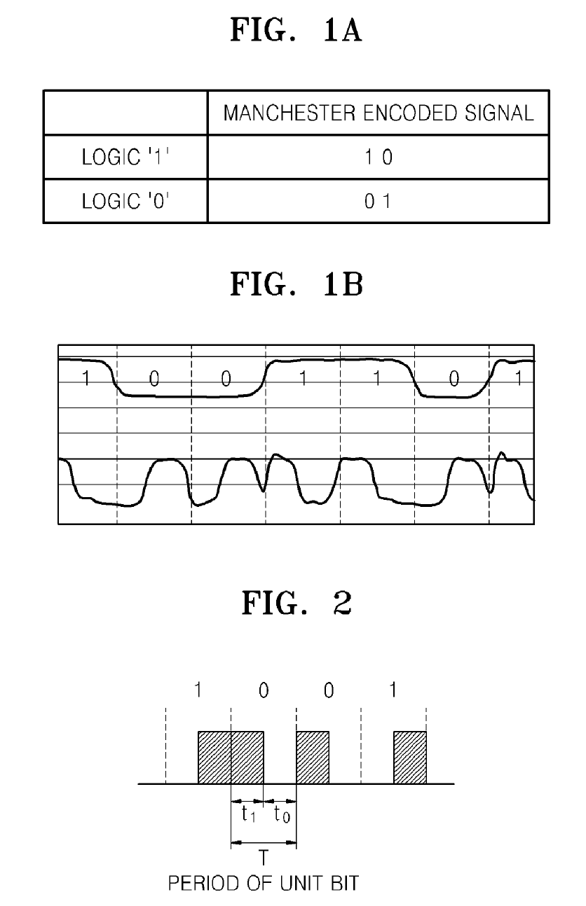

FIGS. 1A and 1B illustrate a Manchester encoded downstream signal according to an embodiment of the present invention. FIG. 1A illustrates the forms of a Manchester encoded signal according to logic data values and FIG. 1B illustrates optically Manchester encoded signals.

Data values of ‘1’ and ‘0’ are encoded into ‘10’ and ‘01’, respectively, in the Manchester encoded signal. The Manchester encoded signal can be obtained from combination of data and a clock signal.

A Manchester encoded optical signal can be obtained by generating a Manchester encoded electrical signal using an electrical logic element such as an exclusive OR (XOR) or a multiplier circuit and modulating the Manchester encoded electrical signal into an optical signal or by optically performing addition or subtraction on data and a clock signal.

When addition or subtraction is used, addition or subtraction electrically performed using an electrical element such as an adder circuit or a subtractor circuit and a result of the addition or subtraction is applied to an optical modulator. Alternatively, a clock signal and data are simultaneously applied to a dual-port optical modulator and output light is adjusted using the optical sum or difference between two signals. In a method using addition or subtraction, Manchester coding is performed by generating an optical output when a data value is the same as a clock value and generating no optical output when a data value is different from a clock value.

FIG. 1B illustrates a Manchester encoded optical signal generated using a dual-port optical modulator. Referring to FIG. 1B, with respect to an upper signal, i.e., an electrical data signal, a lower signal, i.e., a Manchester encoded optical signal is output. The intensity of light when data is ‘1’ is the same as that when data is ‘0’. When a data value changes from ‘0’ to ‘1’, a notch-shape waveform is observed. The notch-shape waveform is generated due to the characteristics of an optical modulator. When an XOR gate is used, the notch-shape waveform is not generated. Even when the notch-shape waveform is generated as illustrated in FIG. 1B, it does not influence to the ability of a receiver to identify a data value, i.e., transmission performance.

FIG. 2 illustrates the relationship between a unit bit and a period in a modified Manchester encoded downstream signal, according to an embodiment of the present invention. The reason why a Manchester encoded signal is used in the present invention is to make a downstream signal always have the constant amount of light per period T of a unit bit and use the downstream signal for an upstream signal.

In the Manchester encoded signal illustrated in FIGS. 1A and 1B, a ratio of a time t₁ while light exists to a time t₀ while light does not exist is 50:50 in a unit bit. When the time t₁ is made to be greater than the time t₀ within a range in which the quality of a downstream signal is not remarkably decreased, the quality of an upstream signal can be increased. In particularly, the speed of an upstream signal can be made to approximate to that of a downstream signal without synchronization. There is no technological difficulty in embodying a modified Manchester encoded signal illustrated in FIG. 2 and entire efficiency can be remarkably increased. In the modified Manchester encoded signal illustrated in FIG. 2, the ratio of the time t₁ while light exists to the time t₀ while light does not exist can be arbitrarily adjusted only if t₀+t₁=T is always satisfied.

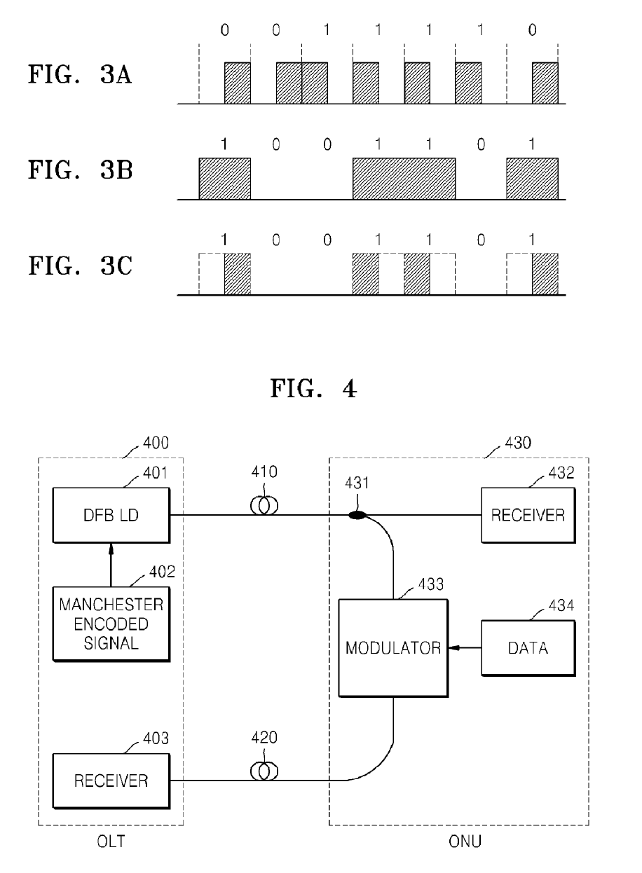

FIGS. 3A through 3C illustrate waveforms of an upstream signal obtained by modulating the Manchester encoded downstream signal illustrated in FIGS. 1A and 1B or FIG. 2. FIGS. 3A through 3C show upstream and downstream signals having data information.

When a data stream ‘0011110’ of a downstream signal is transmitted, it is encoded into a Manchester encoded downstream signal ‘010110101001’ illustrated in FIG. 3A. FIG. 3B illustrates a data stream for an upstream signal. FIG. 3C illustrates an upstream signal generated by remodulating the downstream signal illustrated in FIG. 3A on data upstream illustrated in FIG. 3B. In FIG. 3C, dotted lines indicate a waveform detected by a receiver in a central office. It can be inferred that the data upstream sent by a terminal or an optical network unit (ONU) is detected normally.

Meanwhile, when an upstream signal and a downstream signal have the same data transmission rate, synchronization between the two signals is necessary as illustrated in FIGS. 3A through 3C. However, when the data transmission rate of an upstream signal is at least a particular percent lower than that of a downstream signal, synchronization between the two signals is not necessary.

FIG. 4 illustrates an optical communication system using the Manchester encoded downstream signal illustrated in FIGS. 1A and 1B or FIG. 2, according to an embodiment of the present invention.

The present invention relates to an optical system and method for remodulating a downstream signal transmitted from a central office or an optical line tenninator (OLT) and using a remodulated signal as an upstream signal without using a light source in a terminal. Although the present invention is not restricted to an optical network, embodiments of the present invention will be described based on an optical network.

An OLT 400 in a central office includes a data generator 402 generating a Manchester encoded electrical signal; a light source 401, i.e., a distributed feedback laser diode (DFB-LD) 401 converting the Manchester encoded electrical signal into a Manchester encoded optical signal; and a receiver 403 receiving a modulated upstream signal from an ONU 430.

The ONU 430 includes a divider 431 dividing the power of a Manchester encoded downstream signal by 2, a receiver 432 recovering data transmitted from the OLT 400 from one of two divided optical signals output from the divider 431, and a modulator 433 modulating the other one of the two divided optical signals output from the divider 431 based on data generated by a data generator 434 to be transmitted from the ONU 430 to the OLT 400.

The single-wavelength light source 401 receives a Manchester encoded electrical signal from the data generator 402 such as an XOR logic element, a multiplier circuit, an adder circuit, or a subtractor circuit and converts the electrical signal into an optical signal. In other words, the light source 401 primarily modulates data into a Manchester encoded signal and outputs the Manchester encoded signal. The OLT 400 transmits a downstream signal to the ONU 430 via a downstream optical transmission line 410.

The downstream signal is divided into first and second parts by the divider 431. The first part of the downstream signal is input to the receiver 432 of the ONU 430. The receiver 432 extracts downstream data information from the first part of the downstream signal. The second part of the downstream signal is transmitted back to the OLT 400 via the modulator 433. The ONU 430 remodulates the downstream signal using the modulator 433 based on the data generated by the data generator 434 to convey upstream data information using the downstream signal.

An upstream signal including the upstream data information is received by the receiver 403 of the OLT 400 via an upstream optical transmission line 420. The OLT 400 extracts the upstream data information embedded by the ONU 430 from the upstream signal.

The temporal gain flattening of a downstream signal may be enhanced using gain saturation of a reflective semiconductor optical amplifier (RSOA) in the ONU 430 or an optical network terminal (ONT) to increase the quality of a remodulated upstream signal.

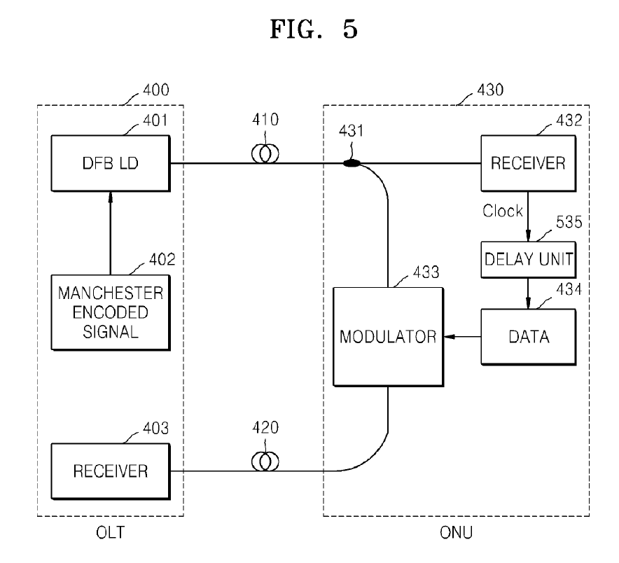

FIG. 5 illustrates an optical communication system using a method of remodulating the Manchester encoded downstream signal illustrated in FIGS. 1A and 1B or FIG. 2 in synchronization with an upstream signal, according to an embodiment of the present invention.

Synchronization is performed using a clock signal recovered by the receiver 432 as a trigger of the data generator 434. For the synchronization, a delay unit 535 is used.

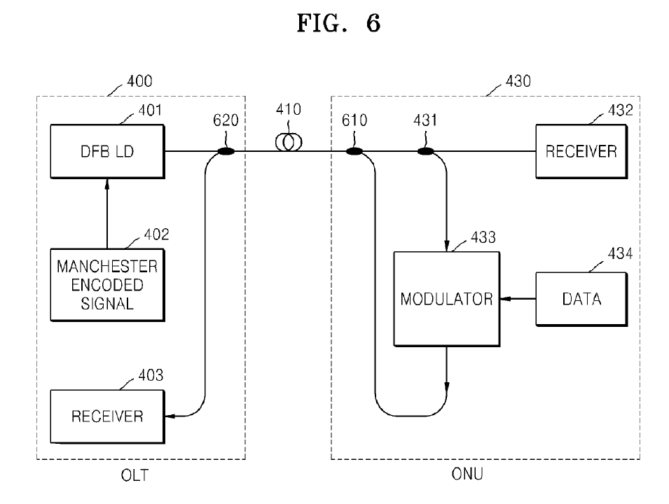

FIG. 6 illustrates an optical communication system using the Manchester encoded downstream signal illustrated in FIGS. 1A and 1B or FIG. 2 with a single strand of optical fiber, according to an embodiment of the present invention. In the optical communication system illustrated in FIG. 6, the OLT 400 and the ONU 430 are connected to each other through a single transmission line 410.

An optical signal output from the modulator 433 is transmitted to the OLT 400 through a divider 610 (or a circulator). The receiver 403 in the OLT 400 receives the optical signal through a divider 620 (or a circulator).

Meanwhile, instead of the modulator 433 used in the optical communication systems illustrated in FIGS. 4 through 6, a semiconductor optical amplifier (SOA) may be used. The SOA has a remodulation function and a signal amplification function.

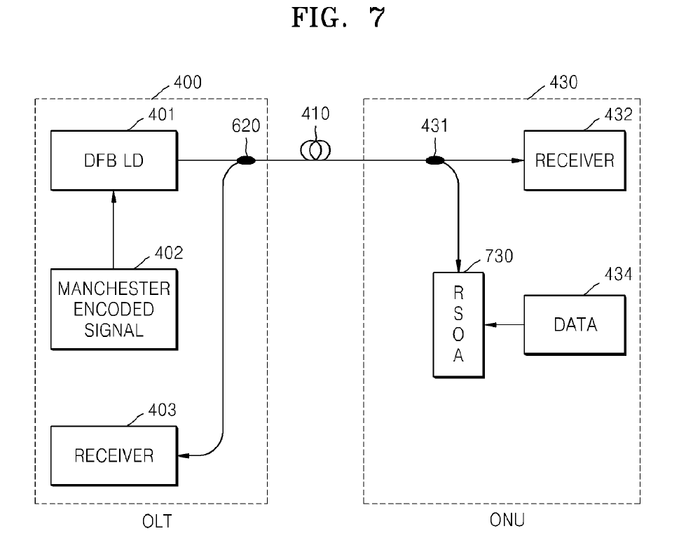

FIG. 7 illustrates an optical communication system using an RSOA instead of the modulator 433 illustrated in FIG. 6, according to an embodiment of the present invention. Instead of the modulator 433 illustrated in FIGS. 4 through 6, an RSOA 730 having the same characteristics as an SOA may be used. A Manchester encoded downstream signal is input to the RSOA 730. The RSOA 730 remodulates the downstream signal through gain control to convey upstream data information using the downstream signal. The remodulated signal is reflected by the RSOA 730 and is transmitted to the OLT 400 via a divider 431.

When an SOA or an RSOA is used in a gain saturation region in an ONU or an ONT, the temporal gain flattening of a downstream signal is enhanced and thus the quality of an upstream signal is increased.

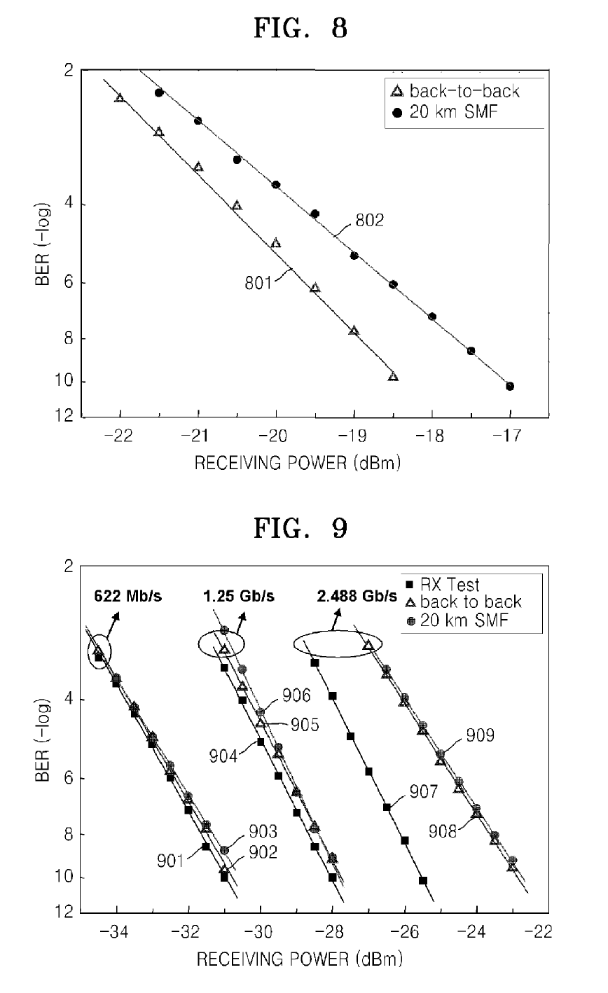

FIG. 8 is a graph showing the results of measuring characteristics of downstream signals transmitted by the optical communication system illustrated in FIG. 4. The graph shows the transmission characteristic of downstream signals into which 5-Gbits/s data is Manchester encoded. A result 801 shows a bit error rate (BER) characteristic of a back-to-back signal of a downstream signal, which is measured at an output port of the light source 401. A result 802 shows a BER characteristic of a signal transmitted via a 20-km single mode fiber (SMF). The graph illustrated in FIG. 8 proves that the transmission characteristic of a Manchester encoded downstream signal is excellent.

FIG. 9 is a graph showing the results of measuring characteristics of upstream signals transmitted by the optical communication system illustrated in FIG. 4. The graph illustrated in FIG. 9 shows the transmission characteristic of an upstream signal that is obtained by remodulating a Manchester encoded downstream signal to include upstream data.

The transmission characteristics of upstream data having transmission rates of 622 Mbits/s, 1.25 Gbits/s, and 2.5 Gbits/s were measured.

Results 901, 904, and 907 show the transmission characteristics of upstream data having transmission rates of 622 Mbits/s, 1.25 Gbits/s, and 2.5 Gbits/s, respectively, when a downstream signal has not been Manchester encoded, that is, the characteristics of a receiver itself. Results 902, 905, and 908 show the characteristics of upstream signals measured at an output port of the modulator 433 that remodulates a Manchester encoded downstream signal to include upstream data having transmission rates of 622 Mbits/s, 1.25 Gbits/s, and 2.5 Gbits/s, respectively. Results 903, 906, and 909 show the characteristics of remodulated upstream signals that have been transmitted via a 20-km single mode fiber with transmission rates of 622 Mbits/s, 1.25 Gbits/s, and 2.5 Gbits/s, respectively.

The characteristic was deteriorated a little (i.e., 2.6 dB power penalty) at the transmission rate of 2.5 Gbits/s due to Manchester coding, but the deterioration of the characteristic rarely occurred at the other lower transmission rates. Meanwhile, characteristic deterioration due to transmission rarely occurred.

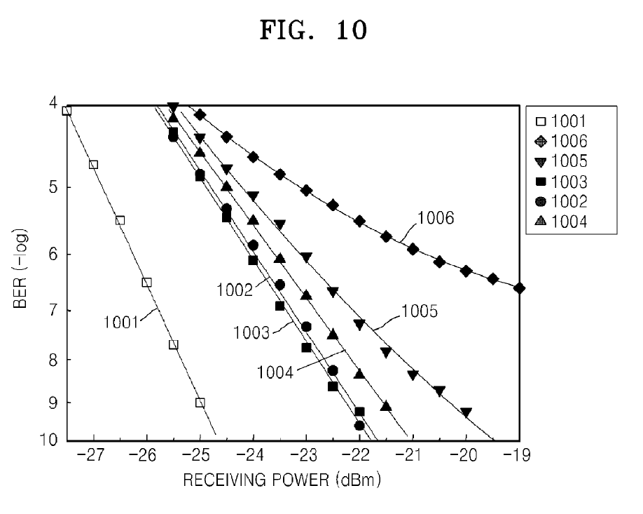

FIG. 10 is a graph showing the results of measuring characteristics of upstream signals transmitted by the optical communication system illustrated in FIG. 5 when the upstream signal and a downstream signal have the same data transmission rate and are synchronized with each other. The graph illustrated in FIG. 10 shows the transmission characteristic of an upstream signals obtained by remodulating a Manchester encoded downstream signal to include upstream data information.

The transmission characteristics of upstream/downstream data having a transmission rate of 2.5 Gbits/s were measured.

A result 1001 shows the transmission characteristic of upstream data having a transmission rate of 2.5 Gbits/s when a downstream signal has not been Manchester encoded, that is, the characteristic of a receiver itself. A result 1002 shows the transmission characteristic of an upstream signal when upstream data is synchronized with and completely coincide with a Manchester encoded downstream signal. Results 1003, 1004, 1005, and 1006 show the transmission characteristics of upstream signals when upstream data is synchronized with a Manchester encoded downstream signal but has time delays of −10 psec, +10 psec, −20 psec, and −30 psec, respectively.

When an upstream signal is not synchronized with a downstream signal, it is almost impossible to transmit upstream data at the same transmission rate as downstream data. However, data can be transmitted with a little characteristic deterioration (e.g., about 3 dB power penalty) by synchronizing the upstream signal with the downstream signal.

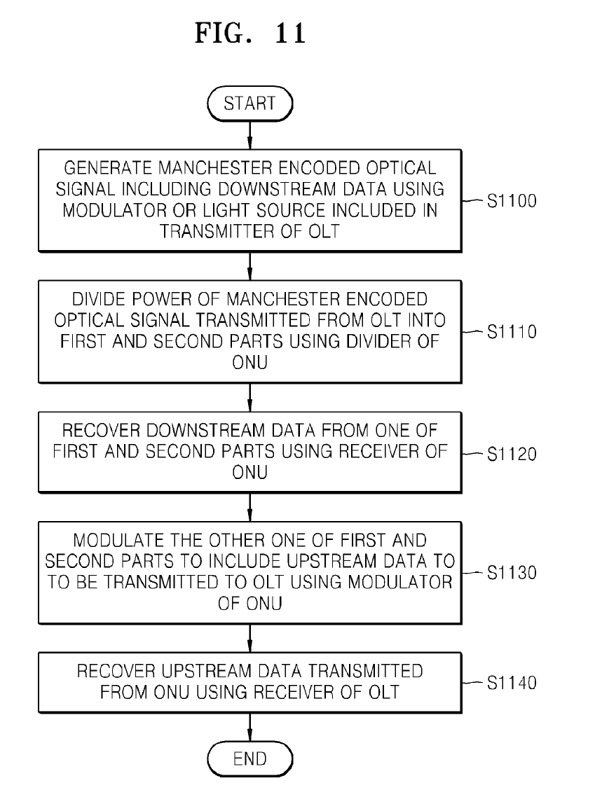

FIG. 11 is a flowchart of an optical communication method performed by the optical communication system illustrated in FIG. 4, according to an embodiment of the present invention.

In operation S1100, a transmitter of the OLT 400 generates a Manchester encoded optical signal including downstream data using a modulator or a DFB LD (i.e., the light source 402). In operation S1110, the divider 431 of the ONU 430 divides the Manchester encoded optical signal transmitted from the OLT 400 into first and second parts. In operation S1120, the receiver 432 of the ONU 430 recovers the downstream data transmitted from the OLT 400 from one of the first and second parts. In operation S1130, the modulator 433 of the ONU 430 optically modulates the other one of the first and second parts to include upstream data to be transmitted to the OLT 400. In operation S140, the receiver 403 of the OLT 400 recovers the upstream data transmitted from the ONU 430.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An optical communication system comprising:
a transmitter generating and transmitting a Manchester encoded optical signal including a first data stream; and
a receiver receiving an optical signal obtained by dividing power of the Manchester encoded optical signal into two parts and modulating one of the two parts to include a second data stream, and recovering the second data stream.

2. The optical communication system of claim 1, wherein a duration of a high level or a low level of the Manchester encoded optical signal does not coincide with a half period of a unit bit in the first data stream.

3. The optical communication system of claim 2, wherein a period of the unit bit is the same as a sum of the duration of the high level and the duration of the low level.

4. The optical communication system of claim 1, wherein the second data stream is synchronized with the first data stream.

5. The optical communication system of claim 1, wherein the second data stream is a non-return-to-zero (NRZ) data signal.

6. The optical communication system of claim 1, wherein the transmitter comprises:
an XOR logic element receiving the first data stream through a first input port and a clock signal through a second input port and generating a Manchester encoded electrical signal; and
a light source converting the Manchester encoded electrical signal into the Manchester encoded optical signal.

7. The optical communication system of claim 1, wherein the transmitter comprises an optical modulator receiving the first data stream through a first input port and a clock signal through a second input port and generating the Manchester encoded optical signal.

8. The optical communication system of claim 1, wherein the transmitter comprises an optical modulator receiving a sum or difference of the first data stream and a clock signal and generating the Manchester encoded optical signal.

9. An optical communication system comprising:
a divider receiving a Manchester encoded optical signal including a first data stream and dividing power of the Manchester encoded optical signal into two parts;
a receiver recovering the first data stream from one of the two parts of the Manchester encoded optical signal; and
a modulator modulating the other part of the Manchester encoded optical signal to include a second data stream.

10. The optical communication system of claim 9, wherein a duration of a high level or a low level of the Manchester encoded optical signal does not coincide with a half period of a unit bit in the first data stream.

11. The optical communication system of claim 10, wherein a period of the unit bit is the same as a sum of the duration of the high level and the duration of the low level.

12. The optical communication system of claim 9, wherein the second data stream is synchronized with the first data stream.

13. The optical communication system of claim 9, wherein the second data stream is a non-return-to-zero (NRZ) data signal.

14. The optical communication system of claim 9, wherein the modulator is a semiconductor optical amplifier.

15. The optical communication system of claim 9, wherein the modulator is a reflective semiconductor optical amplifier.

16. An optical communication system comprising:
a transmitting unit generating a Manchester encoded optical signal including a first data stream;
a modulation unit dividing power of the Manchester encoded optical signal into two parts, recovering the first data stream from one of the two parts, and modulating the other part of the Manchester encoded optical signal to include a second data stream; and
a receiving unit recovering the second data stream added by the modulation unit.

17. The optical communication system of claim 16, wherein a duration of a high level or a low level of the Manchester encoded optical signal does not coincide with a half period of a unit bit in the first data stream.

18. The optical communication system of claim 17, wherein a period of the unit bit is the same as a sum of the duration of the high level and the duration of the low level.

19. The optical communication system of claim 16, wherein the second data stream is synchronized with the first data stream.

20. The optical communication system of claim 16, wherein the second data stream is a non-return-to-zero (NRZ) data signal.

21. The optical communication system of claim 16, wherein the transmitting unit comprises:
an XOR logic element receiving the first data stream through a first input port and a clock signal through a second input port and generating a Manchester encoded electrical signal; and
a light source converting the Manchester encoded electrical signal into the Manchester encoded optical signal.

22. The optical communication system of claim 16, wherein the transmitting unit comprises an optical modulator receiving the first data stream through a first input port and a clock signal through a second input port and generating the Manchester encoded optical signal.

23. The optical communication system of claim 16, wherein the transmitting unit comprises an optical modulator receiving a sum or difference of the first data stream and a clock signal and generating the Manchester encoded optical signal.

24. The optical communication system of claim 16, wherein the modulation unit comprises:
a divider dividing power of the Manchester encoded optical signal into two parts;
a receiver recovering the first data stream from one of the two parts of the Manchester encoded optical signal; and
a modulator modulating the other part of the Manchester encoded optical signal to include a second data stream.

25. The optical communication system of claim 16, wherein the modulation unit comprises:
a divider dividing power of the Manchester encoded optical signal into two parts;
a receiver recovering the first data stream from one of the two parts of the Manchester encoded optical signal; and
an optical amplifier modulating the other part of the Manchester encoded optical signal to include a second data stream and flattening a gain of the modulated optical signal.

26. The optical communication system of claim 25, wherein the optical amplifier is a reflective optical amplifier.

27. An optical communication method comprising:
generating a Manchester encoded optical signal including a first data stream;
dividing power of the Manchester encoded optical signal into two parts, recovering the first data stream from one of the two parts, and modulating the other part of the Manchester encoded signal to include a second data stream: and
recovering the second data stream.

28. The optical communication method of claim 27, wherein a duration of a high level or a low level of the Manchester encoded optical signal does not coincide with a half period of a unit bit in the first data stream.

29. The optical communication method of claim 28, wherein a period of the unit bit is the same as a sum of the duration of the high level and the duration of the low level.

30. The optical communication method of claim 27, wherein the second data stream is synchronized with the first data stream.

31. The optical communication method of claim 27, wherein the second data stream is a non-return-to-zero (NRZ) data signal.

32. The optical communication method of claim 27, wherein the generating of the Manchester encoded optical signal comprises:
receiving the first data stream through a first input port and a clock signal through a second input port and generating a Manchester encoded electrical signal; and
converting the Manchester encoded electrical signal into the Manchester encoded optical signal.

33. The optical communication method of claim 27, wherein the modulating of the Manchester encoded optical signal comprises:
dividing power of the Manchester encoded optical signal into two parts;
recovering the first data stream from one of the two parts; and
modulating the other part of the Manchester encoded optical signal to include the second data stream.

34. The optical communication method of claim 33, wherein the modulating of the Manchester encoded optical signal further comprises flattening a gain of the modulated optical signal.
